(19) United States
(12) Patent Application Publication
(10) Pub. No.: US 2006/0088687 A1
(43) Pub. Date: Apr. 27, 2006

(54) Extrusion system for producing a plastic plate with anchor knobs

(76) Inventor: Ulrich Korner, Hohr-Grenzhausen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/520,245

(22) PCT Filed: Jul. 3, 2003
(86) PCT No.: PCT/EP03/07115

§ 371 Date: Apr. 11, 2005

(30) Foreign Application Priority Data
Jul. 3, 2002 (DE) 102 29 883.1

(51) Int. Cl. B29C 47/00; B32B 7/00

(52) U.S. Cl. 428/119; 264/167; 264/210.2

(57) ABSTRACT

The present invention relates to a device and a method for continuously producing a plastic plate and/or film comprising lugs or anchors that are formed therewith in one piece, wherein the molten plastic is guided in the form of a flat web through a gap between a roll and a circulating device, wherein said circulating device comprises circulating shaping strips having recesses for forming the anchors, and the shaping strips, when passing from a straight section into a curved section of the circulating device, open thereby enabling the formed anchors to be released or ejected without force. The device of the present invention and the method of the present invention enable a continuous production of anchor plates comprising, in particular, non-positive and complicated anchor shapes that can be realized quickly and with a few working steps.

The present invention relates to a device and a method for continuously producing a plastic plate and/or sheet comprising lugs or anchors that are formed therewith integrally or in one piece, wherein the molten plastic is guided in the form of a flat web through a gap between a roll and a circulating device, wherein said circulating device comprises circulating shaping strips having recesses for forming the anchors, and wherein the shaping strips, when passing from a straight section into a curved section of the circulating device, open so that the formed anchors are released or ejected without force.

Plastic plates comprising lugs or anchors and produced in accordance with the present invention are used for lining, covering or encasing buildings or components. Such buildings or components normally consists of concrete, mortar, soil or other pourable materials or viscous materials.

On one or two sides, the plastic plate, sheet or film comprises lugs or anchors by means of which it is connected with the building or component, usually during production thereof. The lugs or anchors serve for a mechanical attachment to the component and, for this purpose, have specific geometrical shapes, preferably with undercuts, depending on the field of application and the material used.

Plastic plates of this kind are used, in particular, as a chemically resistant, fluid and/or gas tight protection of constructions. They guarantee tightness to water, waste water, all kinds of chemicals, acids, lyes or alkaline solutions, as well as gases and other media.

Plastic plates of this kind are used, i.a., in buildings and components, such as tubes, pipelines, tunnels, channels, reservoirs, containers, chimneys, masonry dams, roadways, bridges, foundation plates in cellars as well as external fronts or facades.

Such plates are normally made of thermoplastic materials being highly resistant to temperature and chemicals, such as, e.g., polyethylene, polypropylene, polyvinylchloride (PVC), polyvinylidenefluoride (PVDF), ethylene tetrafluoroethylene (ETFE) as well as special types of said materials that are normally processed in a continuous process.

DE-U-296 15 818 describes a device for producing a protective plate comprising fastening knobs, wherein the device comprises a means for cold shaping the fastening knobs; for mutually pressing the fastening knobs that are arranged in rows, two elongate profiles are provided whose stamping edges are entirely or partly rounded and/or comprise oblique stamping surfaces.

EP-B-0 436 058 discloses an extrusion and calendaring method for producing a plastic plate, in particular for lining concrete containers comprising anchor elements, which consists of planiform wings which are arranged in an approximately V-shaped manner with respect to each other thereby including an angle and being offset with respect to their widths. For this purpose, a roll comprises recesses each having at least two partial recesses for wing elements, said recesses spreading from a surface area of the roll into the interior of the roll and said wing elements extending into the roll in a non-undercut manner. During production, the melt fills the recesses, is cooled and pulled out or extracted from the mold.

DE-A-31 08 972 describes a method in which individual injection-molded knobs are connected with a smooth plastic plate by means of welding.

EP-A-0 294 507 discloses a method and a device for producing knobbed plates, wherein the plates are continuously extruded, wherein the plate blank is passed between two rolls, at least one thereof being a profiled roll, wherein on the one side of the profiled roll the knobs are formed of the material of the plate blank and wherein the formed knobs are passed in a substantially translatory movement through a (cutting) tool forming an undercut.

FR-A-1 102 294 describes a method in which plastic plates are produced by extrusion, wherein during extrusion and caused by the extrusion process, anchor strips, which can also be undercut, are formed on a plate surface over the entire length of the plate.

U.S. Pat. No. 2,816,323 discloses a plastic plate comprising continuous longitudinal rails having a T-profile.

DE-A-29 34 799 discloses a concrete protection plate comprising anchor ribs which extend parallel with respect to each other and comprise channels.

EP-A-0 960 710 discloses a continuous extrusion process for continuously and nondestructively producing plastic plates comprising anchor knobs, wherein a roll comprises different shaping strips; the anchors or webs to be formed are incorporated in the side walls of the shaping strips, and the shaping strips can be lifted by hydraulic or pneumatic cylinders in order to release the resulting anchor plate.

DE-A-25 29 631 describes a shaping means for forming ribs, swellings, journals or upright necks on a shapeable material, which are deformed under pressure.

The non-continuous processes are, i.a., disadvantageous in that a plurality of working steps in a plurality of devices are necessary for producing the anchor plate. This entails an increase in costs and time as compared to continuous extrusion processes. In addition, the subsequent deformation of the anchors or the subsequent attachment of the anchors leads to intersections and/or changes in the material or structure, which has a negative effect on the quality of the plastic plates.

In continuous processes, in which undercut anchor shapes are formed in one plane only, the anchor is extracted or removed from the mold after the melt has cooled. In turn, this leads to the disadvantage that plastic plates that are encased with concrete and produced in the manner described above can be pushed or pulled out of the concrete with relatively low force.

Moreover, continuous processes in which longitudinal webs are produced in the production direction are disadvantageous in that bad results concerning durability etc. have been achieved as compared to punctiform attachments that can be stressed equally in each direction, since in buildings that have to be lined it should be possible to stress the plate in each direction equally.

In strips that open or close by means of hydraulic or pneumatic cylinders, a continuous production guaranteeing at the same time a high quality is difficult due to the great number of cylinders and the complicated and costly control thereof. Moreover, there is the risk that escaping pressurized air has locally a negative effect on the properties of the plastic plate.

Furthermore, in the processes described above the working widths are often limited and there is no possibility to continuously produce individual anchors having undercut shapes, such as, e.g., upside-down truncated cones or web-shaped anchors, transversely with respect to the production direction. It is not possible to produce such shapes with a closed mold or shaping strip. Moreover, the known processes influence the properties of the anchor plate i.a. by cold forming, deformation at the anchor during production, or by welding processes with multi-step production.

It is therefore an object of the present invention to provide a device and method for variably and continuously producing plastic plates and/or films with anchors on one or two sides, wherein the shapes are undercut in one or more planes, such as, e.g. upside-down truncated cones or web-shaped anchors, transversely with respect to the production direction. It is a further object of the present invention to provide a device and a method for continuously producing multi-layer plates and/or plates containing additives and having anchors on one or two sides. Moreover, it is intended to overcome the further disadvantages of the prior art.

These objects are achieved with the features of the claims. The invention starts out from the basic idea to form the anchors of a plastic plate by means of recesses or nests having the shape of the anchor and being formed in shaping strips, wherein along each of its side wall(s) a shaping strip comprises a part of one or more anchor nests and wherein a complete anchor nest is formed by bringing two shaping strips together. Moreover, on a circulating device, which comprises at least a straight section and a curved section, the shaping strips are arranged in such a manner that the shaping strips contact each other in the straight section and form complete nests or recesses for forming the lugs, wherein the shaping strips open with respect to each other in the curved section and thus release the resulting anchors or lugs.

The device of the present invention and the method of the present invention allow a continuous production of plastic anchor plates in one working step and with increased extrusion speed. The shaping strips used for forming the anchors are safely closed during filling, and the resulting anchors can be ejected or released without a specific device and without force or with only a slight force.

By means of the device of the present invention and the method of the present invention it is possible to form, in particular, non-positive anchor shapes, e.g. upside-down truncated cones or truncated pyramids or web profiles arranged transversely with respect to the production direction.

Moreover, it is possible to form anchors or web profiles with harmonically realized cross-sectional transitions in the area of anchor and plate in order to thus guarantee an optimum carrying or loading capacity.

A preferred device of the present invention comprises a circulating device which has a chain or belt drive and to which shaping strips are arranged preferably uniformly. In their edge regions or side walls, the shaping strips comprise recesses having the shape of a portion of a recess for forming the lugs so that two shaping strips that contact each other comprise at least one complete recess for forming at least one lug. The shaping strips are arranged on the circulating device or the chain or belt drive in such a manner that the shaping strips fully contact each other in the straight sections of the circulating device and thus form completely closed recesses for forming the lugs or anchors. In a preferred embodiment of the invention, the shaping strips are arranged on the circulating device in a regularly spaced-apart manner.

In a further preferred embodiment of the invention, the chain or belt drive of the circulating device is stressed such that the shaping strips fully contact each other in the straight sections of the drive. Hydraulic cylinders, spindle lifting gears and/or pneumatic cylinders are preferably used for permanently generating and adjusting a desired state of stress.

For producing the anchor plates, the device preferably comprises a roll which is arranged in such a manner with respect to the circulating device that a gap is formed between circulating device and roll. The molds or nests are filled and the plate is formed in the gap between the shaping strips of the straight section of the circulating device and the guide roll, which can accordingly be positioned in a non-positive or force-fitted manner.

In a preferred embodiment of the present invention, the melt is shaped by extruding it through a slotted nozzle and subsequently passed through the roll gap.

In a particularly preferred embodiment, the temperature of the shaping strips is controlled in such a manner that it is possible to achieve an optimum formation of the anchor plate, an optimum cooling process of the anchor plate and/or optimum properties of the plate, e.g. a particularly low-stress plate.

After cooling the plate and the molds via the shaping strips along the straight section of the circulating device, the shaping strips open and thus also the molds on the curved section of the circulating device, so that the plate and the anchor(s) are released.

In a further preferred embodiment of the present invention, the curved section of the circulating device is circular, wherein the chain or belt drive has a reference diameter D₁ and the shaping strips along the curved section have an average diameter Dₘ, wherein the diameters are related in such a manner that after the end of the straight section and at the beginning of the semicircular section the distance between the shaping strips increases so much due to geometry that the lugs can be ejected. In addition to the anchor dimensions and the above-mentioned diameters, the geometrical conditions during ejection are also influenced by the widths of the shaping strips. For example, with a ratio D₁:Dₘ=1:2 and with a shaping strip width of, e.g., 50 mm, the freed distance between the shaping strips in the circular section is also 50 mm. In a further preferred embodiment, the gap between the shaping strips in the curved section opens due to a corresponding necessary diameter ratio of chain part circle and mold part circle and thus allows a removal of the anchors without force.

The circulating device preferably comprises two straight and two semicircular sections so that, after having been filled with melt in the first straight section and opened in the first circular section, the shaping strips again close along a subsequent second straight portion. In a further subsequent second circular section, the shaping strips open in order to close again firmly in the transition to the first straight section and be filled again. This sequence allows a continuous production.

In a preferred embodiment of the present invention, the shaping strips are brought to a desired temperature while moving along the second straight section and the second circular section.

By changing the spacing between the chain and shaping strips, the distances between the anchors in the longitudinal direction can be selected. By changing the shaping strips, both the transverse distances and also the shapes of the anchors can be changed.

If no specific ratio between reference diameter D₁ of the chain or belt drive and shaping strip diameter Dₘ is selected in case of special anchor dimensions and shaping strip widths, so that at the end of the straight section and at the beginning of the semicircular section an ejection without force is not possible, the distance can also be changed by specially formed wedge-shaped shaping strips in such a manner that an ejection without force is possible.

In the following, the invention will be discussed on the basis of preferred embodiments and the drawings in which

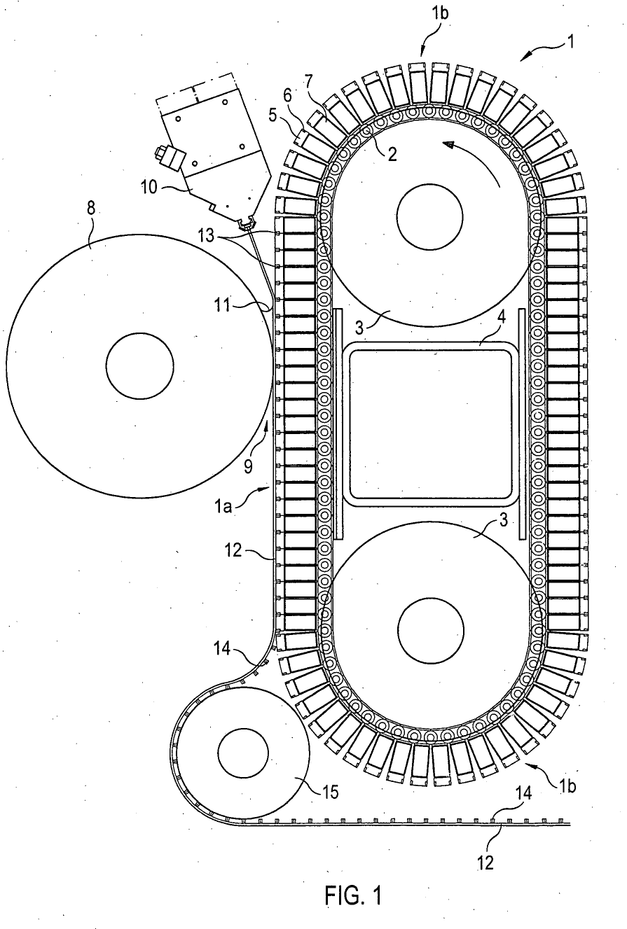

FIG. 1 is a side view of a preferred device of the present invention;

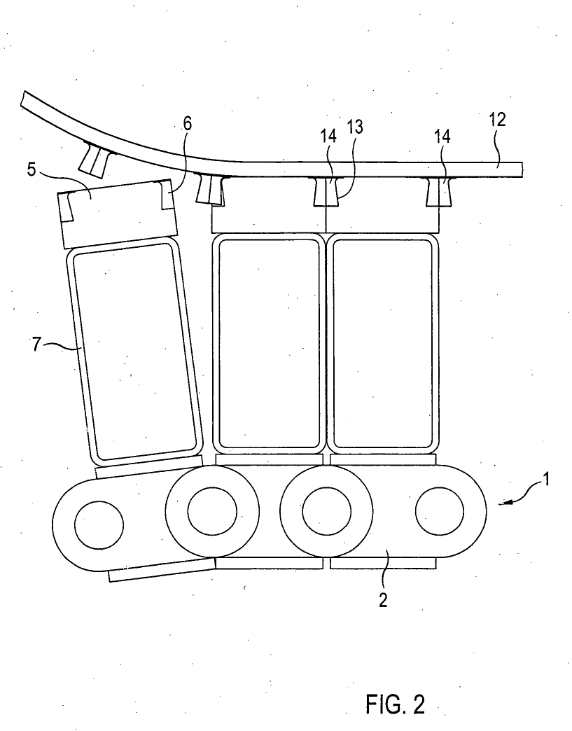

FIG. 2 is a side view of a detail of a preferred device of the present invention;

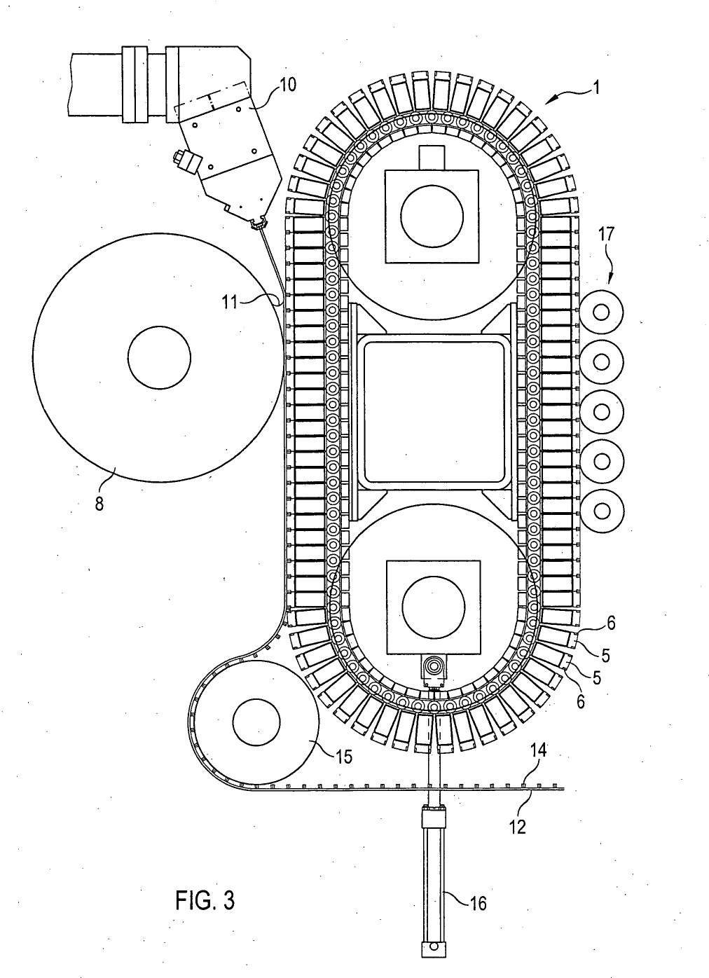

FIG. 3 is a side view of a further preferred embodiment of the present invention;

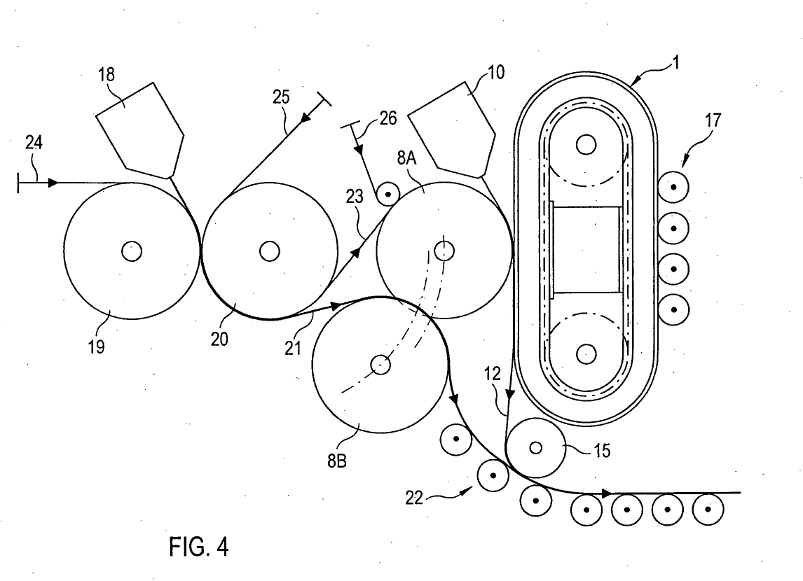

FIG. 4 is a side view of a further preferred embodiment of the present invention;

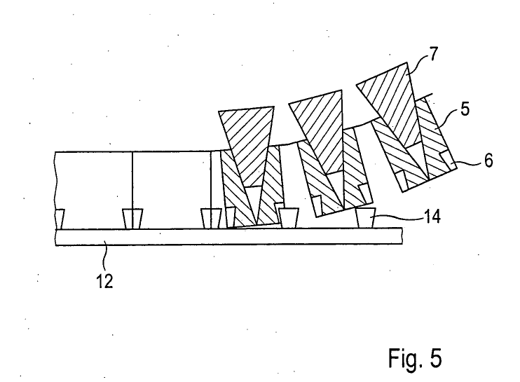

FIG. 5 is a side view of a detail of a further preferred device of the present invention; and

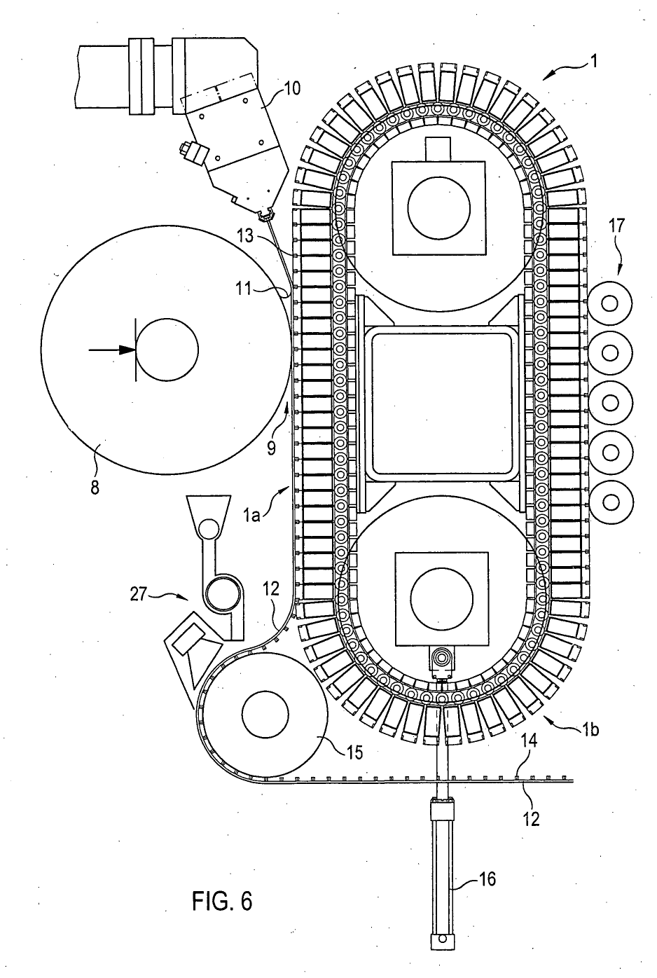

FIG. 6 is a side view of a preferred embodiment of the present invention comprising an application means.

FIG. 1 is a side view of a preferred embodiment of the present invention comprising a circulating device 1 having two straight sections 1a and two circular sections 1b. The circulating device 1 is preferably configured as a chain drive comprising a chain 2, chain wheels 3 as well as an inner support 4. Moreover, shaping strips 5 are arranged at the circulating device 1. On their side walls, the shaping strips 5 comprise at least one recess or cavity or nest 6. In a preferred embodiment of the present invention, each chain member of the chain 2 comprises a support element 7 to which a shaping strip 5 is attached. The shaping strips 5 are preferably arranged at a uniform and constant distance with respect to each other along the circulating device 1. The preferred geometrical configuration of the shaping strips 5 will be explained in more detail below with reference to FIG. 2.

Moreover, the device comprises a roll or guide roll 8 which is arranged in such a manner with respect to the circulating device 1 that a defined gap 9 is formed between the roll 8 and the shaping strips 5 arranged at the circulating device 1.

Through a flat nozzle 10, the plastic melt 11 is introduced between the roll 8 and the circulating device 1. In the gap 9, the plastic or anchor plate 12 is formed and anchor or lug molds 13, which are formed by two shaping strips 5 that contact each other closely, are filled. In a particularly preferred embodiment, the position of the guide roll 8 can be changed for adjusting individual process parameters.

In a particularly preferred embodiment, the shaping strips can be brought to a desired temperature. Thus, it is possible to control the cooling process of the anchor plate 12, which was formed after passing the gap 9, along the straight section 1a of the circulating device 1. In a further preferred embodiment, the support devices 7 are configured such that they bring the shaping strips 5 to a desired temperature. In further preferred embodiments, the shaping strips 5 as such can be brought to a desired temperature. In a preferred embodiment, also the guide roll 8 can be brought to a desired temperature for an optimum adjustment of the production parameters.

When the shaping strips 5 pass from the straight section 1a into the circular section 1b, the shaping strips 5 or recesses 6 open with respect to each other and release the anchors 14 formed on the anchor plate 12.

In a particularly preferred embodiment, the formed anchor plate 12 is supplied to the further process via a roll 15.

By adjusting and controlling the temperature at the different process stages and during the individual process stages, the properties of the anchor plate can be adjusted and optimized. The control of the temperature or temperature curve (variation) is suitable, e.g., for achieving particularly low-stress plates.

FIG. 2 shows a detail of the embodiment of FIG. 1 of the present invention. It shows three chain members of the chain 2 of the circulating device 1, support elements 7 arranged thereon, and shaping strips 5 as well as the formed anchor plate 12 comprising anchors 14 at the transition from the straight section 1a into the semicircular section 1b.

It is clearly evident that the shaping strips 5 contact each other sealingly and in a force-fitted manner at the straight section 1a. Recesses 6 of the shaping strips 5 are formed in such a manner that they each represent a portion of the negative anchor mold and correspond with a corresponding recess 6 of the neighboring shaping strip 5 in such a manner that, when the shaping strips 5 contact each other along the straight section 1a, the recesses 6 together form a recess 13 having the desired negative shape of the anchors 14. The recesses or nests 6 are arranged in a corresponding manner on both side walls of the shaping strips 5 and preferably form one half of the negative anchor mold 13.

In a further preferred embodiment, the side walls of the shaping strips 5 comprise recesses 6 that have different shapes and form the negative anchor mold 13 when the shaping strips contact each other.

When passing from the straight section 1a into the semicircular section 1b, the shaping strips 5 and thus also the recesses 6 open with respect to each other, so that the anchors 14 are ejected or released. The ejection takes place without force, i.e. no additional ejection forces are acting on the anchor 14.

In order to guarantee a full and force-fitted contact between the individual shaping strips along the straight section la, in a preferred embodiment of the present invention the device comprises at least one tensioning device 16 as shown in FIG. 3. Said tensioning devices are preferably hydraulic cylinders, spindle lifting gears and/or pneumatic cylinders. The tensioning device particularly preferably stresses the chain 2, the band or the belt, so that the desired contact between the shaping strips is achieved. In further preferred embodiments of the present invention, there is a form-fitted contact between the shaping strips.

In a further preferred embodiment of the present invention, the circulating device 1 comprises a device 17 along the straight section 1a opposite to the roll 8. The device 17 preferably comprises a plurality of rolls that can be brought to a desired temperature and by means of which the shaping strips are brought to a desired temperature. In a preferred embodiment of the present invention, the device 17 brings the shaping strips to a temperature of about 80° C.

In a particularly preferred embodiment of the present invention, the outer distance between opposing shaping strips 5 is about 94.5 cm along the straight sections 1a, and the corresponding average distance between the chain members of the chain 2 is about 65 cm. The reference diameter of the chain drive is about 66.8 cm. The rolls 8 and 15 have diameters of about 80 cm and 40 cm, respectively.

The ratio between the reference diameter D₁ of the chain or belt drive and the average shaping strip diameter Dₘ is such that when passing from the straight section 1a into the curved section 1b, the shaping strips open so much with respect to each other that no force is necessary for the ejection. The optimum geometry depends on the further geometric values such height and width of the anchor, width of the shaping strips, etc.

The device of the present invention and the method of the present invention make it possible to continuously produce plastic or anchor plates comprising lugs or anchors having complicated geometrical shapes with overlaps in a plurality of planes. In view of the anchor plate 12, preferred anchor shapes are, e.g., upside-down truncated cones or pyramid cones as well as web profiles extending transversely with respect to the production direction, e.g. T-profiles. Depending on the application and requirements, different further geometric anchor shapes can be produced.

In order to vary the anchor shape and the distances between the anchors in the longitudinal and/or transverse directions, in a preferred embodiment of the present invention the reference distance between the chain strips and/or shaping strips can be varied or changed and/or the shaping strips are exchangeable.

By means of further preferred devices of the present invention and/or methods of the present invention, one- or multi-layered plates comprising anchors on one or two sides and/or different shapes can be produced. Preferred embodiments of the present invention allow the production of one- and/or multi-layered anchor plates or sheets which comprise incorporated knitted materials, non-woven materials, metallic sheets or foils as well as glass fibers and/or polyester fibers. Such embodiments allow the use in specific fields of application.

FIG. 4 shows a further preferred embodiment of the present invention. In addition to the flat nozzle 10, the device comprises a further flat nozzle 18 as well as a smoothing system consisting of rolls 19 and 20. Moreover, the roll 8 is preferably pivotable so that it can be brought in at least two positions 8A, 8B. The described device is suitable for variably producing plates having different geometries and properties.

In a preferred embodiment of the device, a plastic melt 18 is introduced through the flat nozzle 18 into the smoothing system between the rolls 19 and 20. The resulting plastic plate 21 is supplied to the roll 8, which is in position 8B, and supplied to the further process via the transport and/or cooling device 22 and the roll 15. In this preferred embodiment of the present invention, smooth plates without anchors can be produced. Also plates with reinforcements and/or additives can be produced in this manner.

In a further preferred embodiment of the embodiment shown in FIG. 4, the roll 8 is in position 8A. The melt supplied through the nozzle 18 is supplied to the roll 8 and the device 1 via rolls 19 and 20. In this way, anchor plates 23 with greater thickness, additives and/or reinforcements, e.g. films or metal foils, can be produced. The plates 23 are preferably about 3 mm to 12 mm thick.

As already discussed with respect to FIGS. 1 to 3, thinner anchor plates are produced by supplying the melt 11 through the nozzle 10 into the gap 9. The thickness of the anchor plates 12 that were produced in this manner is preferably about 1 mm to 3 mm.

In a further preferred embodiment, the roll 8 is in position 8A, wherein both the nozzle 18 and also the nozzle 10 supply melt. Via the roll 8, the resulting plates are brought together in the gap 11 and connected with each other.

In a further preferred embodiment of the present invention, the plate is supplied with a film or any other flat material, e.g., a fabric, non-woven material, knitted material and/or a plastic film or metal foil, and connected therewith.

In a further preferred embodiment of the present invention, the rolls 8, 19, 20 and/or 15 have one or more profiles which are transferred to the melt web and/or plates or films 12, 21 and/or 23. In a further preferred embodiment, two plastic plates comprising anchors that were produced by means of a circulating device 1 and a roll 8 are connected with each other.

FIG. 5 shows a particularly preferred embodiment of the circulating device I and shaping strips 5 and the support devices 7. If there is no specific ratio between the reference diameter D₁ and the average shaping strip diameter Dₘ, so that an ejection without force is not possible at the end of the straight section 1a and at the beginning of the curved section 1b, specifically configured wedge-shaped shaping strips 5 can make it possible to open the shaping strips 5 and the recesses 13 for ejecting the lugs. As shown in FIG. 5, in a particularly preferred embodiment the shaping strips 5 substantially consist of two parts and rest on a wedge-shaped support device 7. Along a straight section 1a, the support devices are inserted in the shaping strips to the greatest possible extent, and the shaping strip parts are thus spread in such a manner that the shaping strips firmly contact each other and form recesses 13 for forming the anchor 14, as described above. Along the curved sections 1b, the wedge-shaped support devices 7 are at least partially pulled out of the shaping strips. The shaping strip parts move towards each other, preferably in contact with the support device 7. Thus, the distance between the shaping strips 5 is reduced so that the shaping strips 5 and recesses 13 open with respect to each other for ejecting the lugs. In a further preferred embodiment, the shaping strips 5 and the support devices 7 move in the area of the curved section on differently curved planes.

FIG. 6 shows a further preferred embodiment of the present invention, wherein said embodiment is arranged with respect to the plastic powder application device 27 in such a manner that the plastic powder is applied to the plate 12, 21, 23 as shortly as possible or directly after ejection, so that the selfenergy or intrinsic energy of the plate (heat) can be used for adhering the powder to the plate. Due to the adhesion of the powder or granules, a nonskid surface of the plate 12, 21, 23 is achieved. The utilization of the intrinsic energy of the plate allows a particularly economical production. In a further preferred embodiment, the adhesion of the powder to the plate is supported by the use of radiators. Particularly preferably, the plastic powder application device 27 is used in the area of the deflection roll 15.

In a further preferred embodiment of the present invention, the device is used in combination with further devices such as one or more edge cutting device(s), thickness measurement device(s), cross cutting disk saw(s) and/or a traction system. After production, the anchor plates 12 can thus be further processed, cut in size, manufactured into plates or coiled and/or subjected to a quality control.

The device according to the present invention is preferably arranged horizontally, vertically or in a specific angle, and the melt can be supplied from the top, bottom, side or in a specific angle. A combination of the described embodiments leads to further preferred devices and methods of the present invention.

The device of the present invention and the method of the present invention enable a continuous production of anchor plates comprising, in particular, force-fitted and complicated anchor shapes that can be realized quickly and with a few working steps.

1. A device for producing plastic plates (12, 21, 23) comprising lugs (14) on at least one side, wherein the lugs (14) are formed integrally with said side, said device comprising
a circulating device (1) and a roll (8) that can be adjusted thereon,
wherein the circulating device (1) comprises at least one straight section (1a) and at least one curved section (1b),
wherein
(a) shaping strips (5) are arranged on the circulating device (1),
(b) the shaping strips (5), which comprise on each of their neighboring side walls a corresponding part (6) of at least one recess or one nest (13) for forming the lugs (14), contact each other in the straight section (1a) of the circulating device (1) in such a manner that corresponding recesses (6) of neighboring shaping strips (5) form a closed recess or a nest (13), and
(c) the shaping strips (5) open in the curved section (1b) for ejecting the lugs (14).

2. The device according to claim 1, wherein a plastic melt is shaped by extrusion through a slotted nozzle (10) and subsequently passed through at least one roll gap (9) between the circulating device (1) and the roll (8).

3. The device according to claim 1, wherein the circulating device (1) comprises a chain (2), a band or a belt.

4. The device according to claim 1, wherein the curved section (1b) is circular.

5. The device according to claim 1, wherein the temperature of the shaping strips (5) and/or the adjusted roll (8) is controllable or adjustable.

6. The device according to claim 1, wherein the shaping strips (5) comprise one or a plurality of individual recesses (6) along their widths.

7. The device according to claim 1, wherein, with respect to the plastic plate, the recesses (13) have the shape of upside-down truncated cones.

8. The device according to claim 1, wherein the shaping strips (5) comprise one or a plurality of web- and/or strip-shaped recesses (6).

9. The device according to claim 1, wherein the shaping strips (5) are variable and/or exchangeable.

10. The device according to claim 1, wherein the shaping strips (5) are made of dimensionally stable materials such as steel, aluminum and/or the like.

11. The device according to claim 1, wherein the shaping strips (5) are arranged along the circulating device (1) in regular intervals.

12. The device according to claim 3, wherein the stress of the circulating device (1) and/or the chain (2), band or belt can be generated and/or adjusted by means of a tensioning device (16).

13. The device according to claim 12, wherein the tensioning device comprises at least a hydraulic cylinder, a spindle lifting gear and/or a pneumatic cylinder.

14. The device according to claim 12, wherein the stress causes the shaping strips (5) to contact each other in a force-fitted manner along the straight section (1a).

15. The device according to claim 1,The device according to any one of the preceding claims, wherein, due to a corresponding ratio between reference diameter (D₁) of the circulating device (1) and average diameter (Dₘ ) of the shaping strips (5), the shaping strips (5) which contact each other in the straight section (1a) open in such a manner with respect to each other when passing from the straight section (1a) into the curved section (1b) that they release the lugs (14) formed in the recesses (13).

16. The device according to claim 1, wherein the shaping strips (5) which contact each other in the straight section (1a) rest on a wedge-shaped support device (7) so that they open in such a manner with respect to each other when passing from the straight section (1a) into the curved section (1b) that they release the lugs (14) formed in the recesses (13).

17. The device according to claim 1, wherein the plate is made of polyethylene, polypropylene, polyvinylchloride (PVC), polyvinylidenefluoride (PVDF), ethylene tetrafluoroethylene (ETFE), special types of said materials or a combination thereof.

18. The device according to claim 1, wherein a second film web or plastic plate (23) is supplied to the roll (8) and the circulating device (1) and connected with the plastic plate (12) to form a homogeneous plate.

19. The device according to claim 1, wherein the roll (8) is pivotable in at least two positions (8A, 8B).

20. The device according to claim 19, wherein a nozzle (18) as well as a smoothing system consisting of rolls (19, 20) for producing films and/or plastic plates (21, 23) are arranged in such a manner that the plastic plates can be supplied to the roll (8) in both positions (8A, 8B).

21. The device according to claim 20, wherein at least a second circulating device (1) according to said claim 20 is arranged in such a manner with respect to the first device that the resulting plastic web comprises anchors on both sides.

22. The device according to claim 1, wherein the device comprises means (24, 25, 26) for supplying additives and connecting them with the plastic plate (12, 21, 23).

23. The device according to claim 22, wherein the additives are flat materials such as a fabric, non-woven material, knitted material, metal foil and/or plastic film.

24. The device according to claim 23, wherein the additives are drawn in by a roll (8, 19, 20) and connected with the melt of the plastic plate (12, 21, 23).

25. The device according to claim 22, wherein the additives and/or flat materials are positioned on and/or between the plates (12, 21, 23).

26. The device according to claim 20, wherein at least one of the rolls (8, 15, 19, 20) has a profile which is transferred to at least one of the plastic plates (12, 21, 23).

27. The device according to claim 1, wherein the device can be arranged horizontally, vertically or in a specific angle and wherein the melt can be supplied from the top, bottom, side or in a specific angle.

28. The device according to claim 1, wherein the device is arranged in such a manner with respect to a plastic powder application device (27) that directly after formation of the plastic plate (12, 21, 23) its intrinsic energy can be used for achieving an adhesion of the powder to the plate (12, 21, 23).

29. A method for producing plastic plates (12, 21, 23) which comprise lugs (14) that are integrally formed therewith on at least one side by using a device according claim 1.

30. The method according to claim 29, wherein a flat molten plastic web is pressed through the gap (9) between the straight section (1a) of the circulating device (1) and the roll (8) adjusted thereon.

31. A method for producing plastic plates (12) which comprise lugs (14) that are integrally formed therewith on at least one side, characterized in that
melt is shaped by extrusion through a slotted nozzle (10) and subsequently passed through at least one roll gap (9) between a circulating device (1) and a roll (8) adjusted thereon,
wherein the circulating device (1) comprises at least one straight section (1a) and at least one curved section (1b),
wherein neighboring shaping strips (5), which comprise along their side walls a corresponding part (6) of at least one recess or nest (13) for forming the lugs (14), contact each other in a closed state at the straight section (1a) of the circulating device (1) in such a manner that corresponding recesses (6) of neighboring shaping strips (5) form a closed recess or a nest (13), wherein the plastic plate (12) and the lugs (14) are formed in the gap (9) and in the recesses (13), respectively, and
wherein in the curved section (1b) the neighboring shaping strips (5) open in such a manner with respect to each other that they release the lugs (14) formed in the recesses (13).

32. The method according to claim 31, wherein, due to a corresponding ratio between reference diameter (D₁) of the circulating device (1) and average diameter (Dₘ) of the shaping strips (5), the shaping strips (5) which contact each other in the straight section (1a) open in such a manner with respect to each other when passing from the straight section (1a) into the curved section (1b) that they release the lugs (14) formed in the recesses (13).

33. A plastic plate (12, 21, 23) comprising lugs (14) and being produced in accordance with the method according to claim 31.

34. A plastic plate (12, 21, 23) comprising lugs (14) and being produced by means of a device according to claim 1.
